(19) United States
(12) Patent Application Publication
(10) Pub. No.: US 2007/0251130 A1
(43) Pub. Date: Nov. 1, 2007

(54) Calendar and Yearly Information Transfer System

(76) Inventor: Sonja Miller, Greenfield, IA (US)

Correspondence Address: PATWRITE LLC, 408 W. MAIN ST., MARSHALLTOWN, IA, 50158-5759, US

(21) Appl. No.: 11/739,970

(22) Filed: Apr. 25, 2007

Related U.S. Application Data
(60) Provisional application No. 60/794,713, filed on Apr. 26, 2006.

(51) Int. Cl. G09D 3/04

(52) U.S. Cl. 40/119

(57) ABSTRACT

The present invention is for a calendar and calendaring system that comprises a calendar with stacked pages which are removably attached to a base portion. The pages are indexed with at least a portion of each stacked page being visible without manipulation. A memorandum/note section is provided for each page that corresponds to a future period of time and is revealed when the previous page is removed allowing the user to record future events to be transferred to a new calendar according to the present invention.

### RELATED APPLICATIONS

This application claims priority and herein incorporates by reference U.S. provisional patent application 60/794,713, filed Apr. 26, 2006.

### BACKGROUND OF THE INVENTION

Although electronic calendars and planners are quite common, not everyone chooses to use an electronic device to keep track of their schedules and important calendar dates like birthdays and anniversaries. Additionally, some people choose to have a written backup even if they use an electronic device since devices can fail with a catastrophic loss of important information.

Of course, calendars are well known and a user may simply write down information on a calendar, but once the calendar becomes obsolete, it becomes difficult to search through the expired calendar to transfer important information to a new calendar. It can be very frustrating to miss an important date such as a birthday because you can't find the date on last year's calendar.

Electronic calendars help with this problem due to the ability to make dates recurring according to predefined rules such as every March 3, or the third Tuesday of every month. However, as discussed above, electronic devices can fail, be lost or the program used becomes obsolete and can't be used anymore leaving the user without a means to retrieve the data.

A need for a reliable and easy method of keeping track of important dates while allowing a user to easily transfer that data to a new calendar exists.

### SUMMARY OF THE INVENTION

The present invention is for a calendar and calendaring system that comprises a calendar with stacked pages which are removably attached to a base portion. The pages are indexed with at least a portion of each stacked page being visible without manipulation. A memorandum/note section is provided for each page that corresponds to a future period of time and is revealed when the previous page is removed allowing the user to record future events to be transferred to a new calendar according to the present invention.

Other features and advantages of the instant invention will become apparent from the following description of the invention which refers to the accompanying drawings.

### BRIEF DESCRIPTION OF THE DRAWINGS

FIG. 1 is an illustration of a calendar according to the present invention.

FIG. 2 is an illustration of the calendar shown in FIG. 1 with a page removed.

FIG. 3 is an illustration of the calendar shown in FIG. 1 with more pages removed.

FIG. 4 is an illustration of a calendar according to another embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

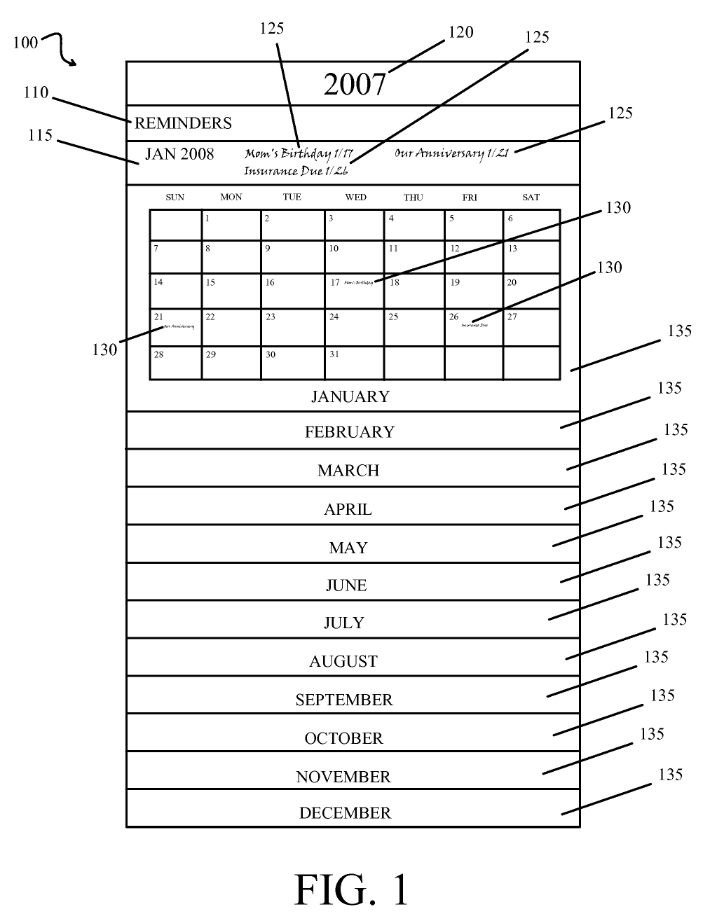

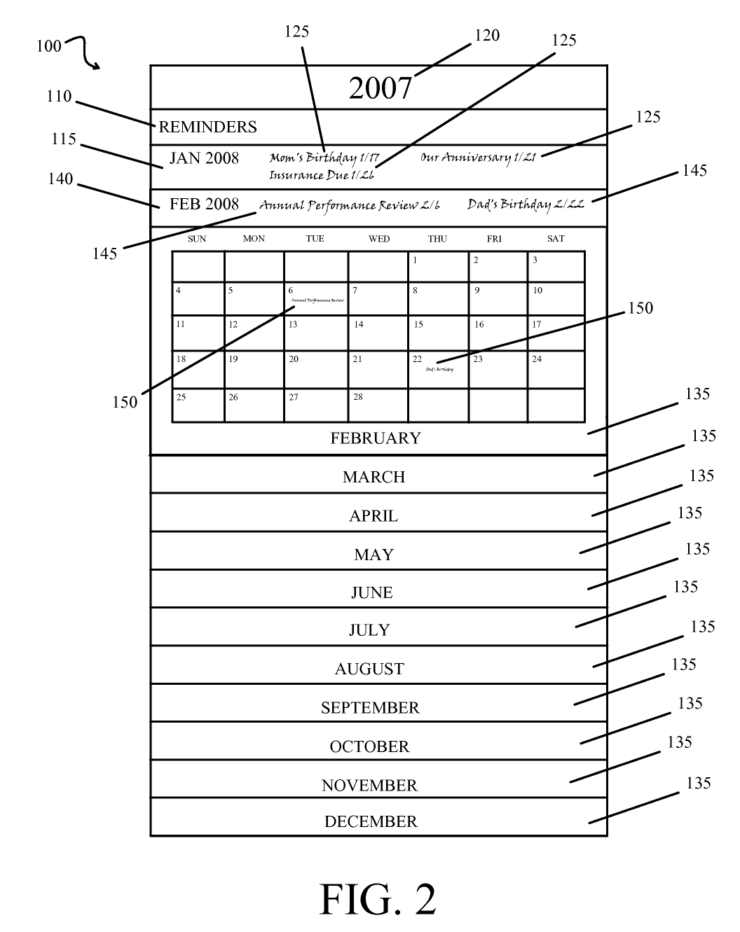

Referring now to FIGS. 1 through 3, a calendar 100 according to the present invention has a base portion 120 which may be printed with information such as the current calendar year and a reminder section 110. Base portion 120 has a plurality of memorandum spaces that allow a user to record events that will take place in the future.

A plurality of monthly pages 135, 136, 138 and 210 are removably attached to base portion 120. Calendar pages 135, 136, 138 and 210 may be attached with removable glue or other removable fastening means such as staples or perforations as is known in the art. Calendar events 125 correspond to events placed on January calendar page 135 in appropriate daily spaces 130. Plurality of monthly pages 135, 136, 138 and 210 are basically the same size but are positioned so that a portion of each page is simultaneously visible whereby a user may select an individual calendar page by pulling back the other pages.

A plurality of memorandum spaces 115, 140, 160, 165, 170, 175, 180, 185, 190, 195, 200 and 205 are covered by calendar pages 135, 136 and 138 until the individual pages are removed. Calendar events such as birthdays, anniversaries and other events are easily transferred to a new calendar simply by referring to the corresponding memorandum space and writing the event on the new calendar. This allows a user to easily transfer information from year to year.

Calendar 100 is shown with January calendar page 135 removed exposing February calendar page 136. February memorandum space 140 is exposed when January calendar page 135 is removed. February calendar events 145 are noted in February's memorandum space 140 and correspond to February calendar items 150.

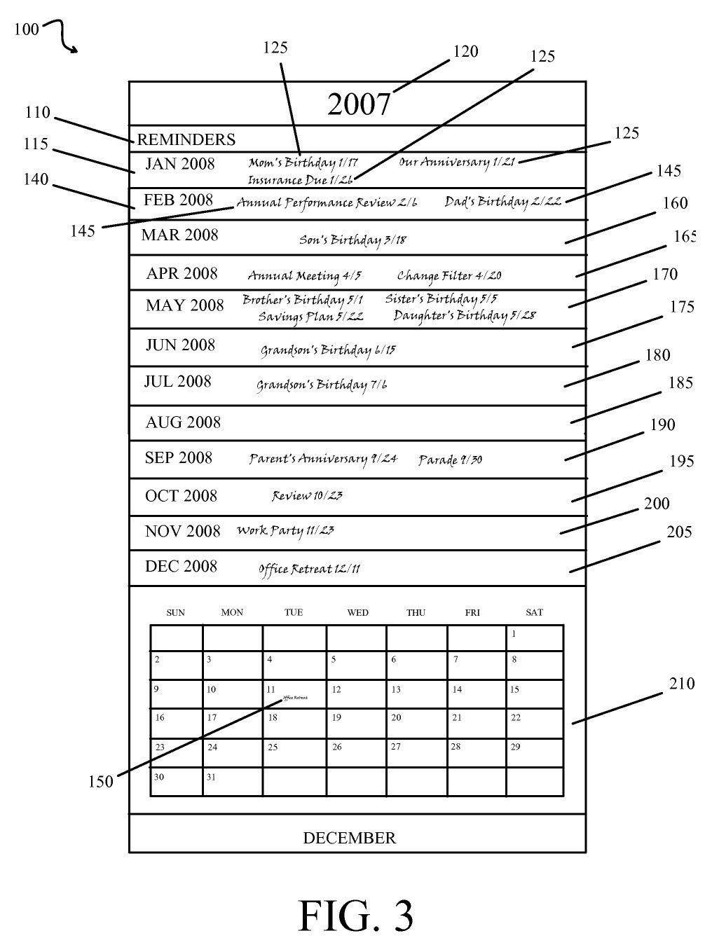

FIG. 3 is shown with all calendar pages removed thereby exposing monthly memorandum spaces 115, 140, 160, 165, 170, 175, 180, 185, 190, 195, 200 and 205. Base portion 120 may be made of card stock, paper, tag board, plastic, metal or any suitable base material as is known in the art. Calendar pages 135, 136, 138 and 210 may be made of the same material as base portion 120 or may be manufactured of any suitable material as is known in the art. Base portion 120 may be made of a metal such as iron or steel with calendar pages printed on flexible magnetic sheets. December calendar page 210 may be printed on base portion 120 or may be a removable sheet like the other calendar sheets.

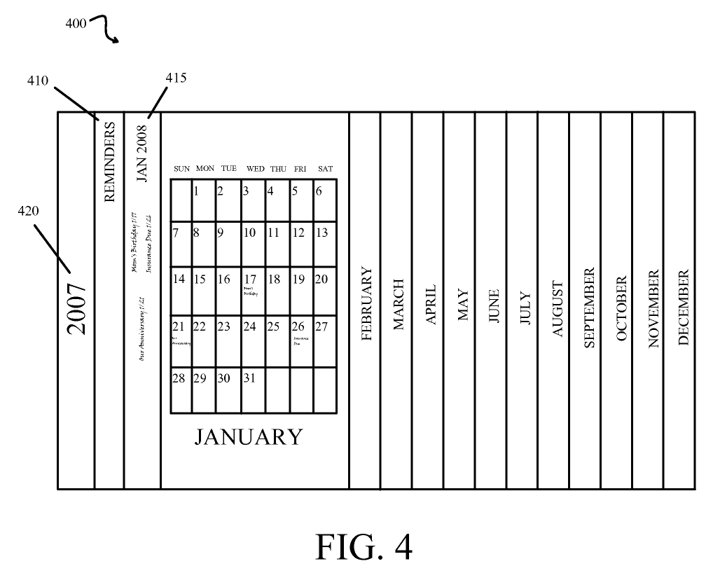

Now referring to FIG. 4, a horizontal calendar 400 is shown having a base portion 420, a reminder space 410 and a plurality of memorandum spaces 415. Memorandum spaces 415 are vertically oriented to allow a user to record calendar events as discussed above. This embodiment is useful as a desk calendar.

Although the instant invention has been described in relation to particular embodiments thereof, many other variations and modifications and other uses will become apparent to those skilled in the art.

What is claimed is:

1. A calendar comprising:
a base portion;
a plurality of consecutive pages removably attached to said base portion;
said plurality of pages being individually removable;
said plurality of pages having at least one calendar printed therein;
a plurality of consecutive individual memorandum spaces disposed on said base portion; and
said plurality of consecutive individual memorandum spaces substantially covered by said plurality of consecutive pages whereby said plurality of individual consecutive memorandum spaces are exposed individually when one of said plurality of consecutive pages is removed.

2. A calendar according to claim 1 wherein said plurality of consecutive pages are progressively positioned offset whereby a portion of said plurality of consecutive pages are simultaneously visible.

3. A calendar according to claim 2 wherein said plurality of consecutive individual memorandum spaces are disposed horizontally under a corresponding upper portion of said plurality of consecutive pages.

4. A calendar according to claim 3 wherein said plurality of consecutive individual memorandum spaces are vertically disposed under a corresponding side portion of said plurality of consecutive pages.

5. A calendar according to claim 1 wherein each of said plurality of consecutive pages includes at least one calendar month printed therein.

6. A calendar according to claim 1 wherein each of said plurality of consecutive pages includes at least three calendar months printed therein.

7. A calendar according to claim 1 wherein each of said plurality of consecutive individual memorandum spaces include a printed month dated one calendar year from the calendar month showing on an uppermost page of said plurality of consecutive pages.

8. A calendar according to claim 1 wherein said base portion is made of cardboard.

9. A calendar according to claim 1 wherein said base portion is made of plastic.

10. A calendar according to claim 1 wherein said base portion is made of metal.

11. A calendar according to claim 1 wherein said base portion is made of a magnetic metal.

12. A calendar according to claim 11 wherein said plurality of calendar pages are printed on a magnetic material.
